(19) United States
(12) Patent Application Publication
(10) Pub. No.: US 2009/0201007 A1
(43) Pub. Date: Aug. 13, 2009

(54) METHOD FOR DETERMINING AN ANODE CONVERSION DEGREE IN A FUEL CELL SYSTEM

(75) Inventors: Andreas Ehlers, Neubrandenburg (DE); Su Zhou, Shanghai (CN)

Correspondence Address: DICKINSON WRIGHT PLLC, 1875 Eye Street, NW, Suite 1200, WASHINGTON, DC, 20006, US

(73) Assignee: ENERDAY GmbH, Stockdorf (DE)

(21) Appl. No.: 12/440,196

(22) PCT Filed: Aug. 3, 2007
(86) PCT No.: PCT/DE2007/001382

§ 371 Date: Mar. 5, 2009

(30) Foreign Application Priority Data
Sep. 13, 2006 (DE) 10 2006 042 995.8

(51) Int. Cl. G01N 27/00; H01M 2/02

(52) U.S. Cl. 324/71.1; 429/34

(57) ABSTRACT

The invention relates to a method for diagnosing an anode conversion degree of a fuel cell or a fuel cell stack (20).

In accordance with the invention it is provided for that diagnosing the anode conversion degree is performed by measuring at least one current of the fuel cell or of the fuel cell stack (20), an air volume flow fed to an afterburner (24), receiving no fuel supply at the time of measurement, an air ratio of a reformer gas and an oxygen volume proportion in an afterburner exhaust gas.

The invention relates to a method for determining an anode conversion degree in a fuel cell or fuel cell stack.

In addition, the invention relates to a fuel cell system including a controller.

Known generally are fuel cell systems, for example, solid oxide fuel cell (SOFC) systems, in which a reformer, a fuel cell or a fuel cell stack and an afterburner are coupled to each other in this sequence. The reformer reacts its supply of air and fuel into a hydrogenated and monocarbonated gas respectively into a reformate. This reformate then gains access to an anode of the fuel cell or of the fuel cell stack. More particularly, the reformate is supplied via an anode inlet to the fuel cell stack. In the anode the reformate (H₂, CO) is partly oxidized catalytically with electron emission and exhausted via an anode outlet. The electrons are drained from the fuel cell or fuel cell stack and flow, for example, to an electrical consumer. From there the electrons gain access to a cathode of the fuel cell or fuel cell stack, a reduction occurring with cathode air fed to a cathode inlet. After this, the cathode exhaust air is discharged via a cathode outlet. The exhaust gases of the fuel cell stack (depleted reformate) as discharged from both the anode outlet and cathode outlet are then both fed to the afterburner. Here, the depleted reformate is reacted with an afterburner air feed into a combustion exhaust gas. To diagnose system performance, use can be made, for example, of the anode conversion degree. At this time, however, there is no way of measuring the anode conversion degree without having to make recourse to complicated methods of gas analysis of the reformate upstream of the fuel cell or fuel cell stack. Employing such methods of gas analysis is unfortunately very costly.

The invention is thus based on the object of sophisticating generic methods and generic fuel cell systems such that diagnosing the anode conversion degree is now possible cost-effectively.

This object is achieved by the features of the independent claims.

Advantageous aspects and further embodiments of the invention read from the de-pendent claims.

The method in accordance with the invention is a sophistication over generic prior art in that diagnosing the anode conversion degree is performed by measuring at least one current of the fuel cell or of the fuel cell stack, an air flow rate fed to an afterburner, receiving no fuel supply at the time of measurement, an air ratio of a reformer gas and an oxygen volume part in an afterburner exhaust gas. By measuring these quantities the anode conversion degree can now be diagnosed cost-effectively by suitable computations. All that is needed to measure the current of the fuel cell or fuel cell stack is an ammeter. The air flow rate fed to the afterburner can be detected by means of a flow meter. The air ratio of the reformer gas and the oxygen volume part in the after-burner exhaust gas can each be sensed by a lambda sensor sited correspondingly at a reformer and at an afterburner.

The method in accordance with the invention can be sophisticated to advantage in that the anode conversion degree is formed by the ratio of combustion gases reacted by an anode at a current I to the combustion gases supplied to the anode as is defined by

$$\frac{N \frac{I}{2 F}}{{\sum }_{j = {H}_{2} , CO , BS} {\dot{n}}_{j}^{A , in}} = \frac{N \frac{I}{2 F}}{N \frac{I}{2 F} + {\dot{n}}_{{H}_{2}}^{A , out} + {\dot{n}}_{CO}^{A , out} + {\dot{n}}_{BS}^{A , out}} ,$$

where I is the current of the fuel cell or of the fuel cell stack, N is the number of fuel cells, F is the faraday constant and \dot{n}_{H}_{₂}^{A,out}, \dot{n}_{CO}^{A,out}, \dot{n}_{BS}^{A,out} are each mol flows of H₂, CO and fuel at an outlet of the anode.

In addition the method in accordance with the invention may be performed such that the sum of the mol flows of \dot{n}_{H}_{₂}^{A,out}, \dot{n}_{CO}^{A,out}, \dot{n}_{BS}^{A,out} equals

$$2 \frac{1}{{λ}_{NB}} \frac{0.21 \cdot {\dot{V}}_{air}^{NB}}{60 \cdot {V}_{m , air}} ,$$

where \dot{V}ₐᵢᵣ^{NB} is the air volume flow supplied to the afterburner, □_{NB} is the air ratio of the afterburner exhaust gas and V_{m,air} is the mol volume of air.

In this context it may be provided for to achieve the method in accordance with the invention such that the air ratio of the afterburner exhaust gas is defined for a super-stoichiometric combustion as

$${λ}_{NB} = \frac{1 + ( \frac{2}{{ϕ}^{A , out} ( {H}_{2} , CO )} - 1 ) \cdot {ϕ}_{NB} ( {O}_{2} )}{1 - \frac{{ϕ}_{NB} ( {O}_{2} )}{0.21}} ,$$

where φ^{A,out} (H₂,CO) is the volume part of H₂ and CO at the anode outlet and φ_{NB} (O₂) is the volume part of O₂ in the afterburner exhaust gas.

In the scope of a further advantageous aspect of the method in accordance with the invention it is provided for that the volume part of H₂ and CO at the anode outlet is defined as

$${ϕ}^{A , out} ( {H}_{2} , CO ) = {ϕ}^{A , in} ( {H}_{2} , CO ) - I \cdot \frac{1}{{\dot{n}}_{Σ}^{A , in}} \cdot \frac{N}{2 F} ,$$

where φ_{A,in} (H₂,CO) is the volume part of H₂ and CO at an anode inlet of the anode and \dot{n}_{Σ}^{A,in} is the total mol flow at the anode inlet.

Preferably the method in accordance with the invention is sophisticated in that the volume part of H₂ and CO at the anode inlet is mapped by means of characteristics as a function of the air ratio of the reformer gas and respectively the air ratio for the reformer. In this case the characteristics may be mapped empirically.

In addition, the method in accordance with the invention may be performed to advantage in that the total mol flow at the anode inlet is mapped by means of characteristics as a function of the air ratio of the reformer gas. Here again the characteristics may be mapped empirically.

In addition, the method in accordance with the invention is preferably achieved so that the total mol flow at the anode inlet is further mapped as a function of a total mol flow into a reformer defined as

$${\dot{n}}^{Ref , i n} = ( 1 + {λ}_{Ref} \cdot \frac{n + \frac{m}{4}}{0 , 21} ) \cdot \frac{{P}_{Ref}}{{h}_{u , fuel} \cdot {M}_{fuel}} ,$$

where n is a carbon concentration and m an hydrogen concentration of the fuel, h_{u,fuel} is the lower specific calorific value of the fuel, M_{fuel} the mol mass of the fuel and P_{ref} is the reformer fuel power.

Likewise, a fuel cell system in accordance with the invention is provided with a controller suitable for implementing the method in accordance with the invention. This results in the properties and advantages as explained in conjunction with the method in accordance with the invention to the same or similar degree and thus reference is made to the comments in this respect as to the method in accordance with the invention to avoid tedious repetition.

The invention will now be detailed by way of particularly preferred embodiments with reference to the attached drawings in which:

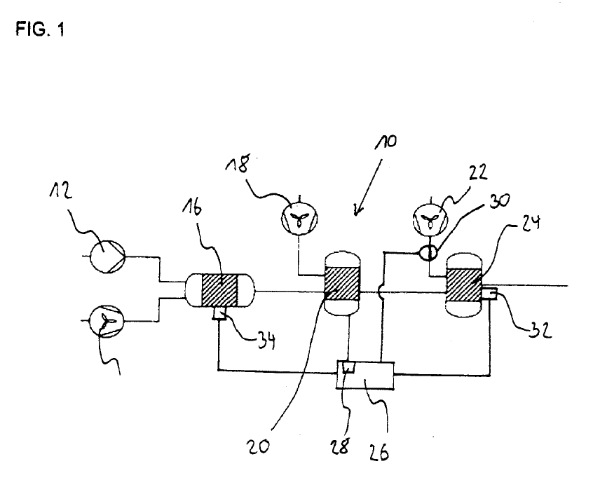

FIG. 1 is a diagrammatic representation of a fuel cell system in accordance with the invention.

Referring now to FIG. 1 there is illustrated a diagrammatic representation of a fuel cell system 10 in accordance with the invention. In the case as shown, the fuel cell system 10 comprises a reformer 16 coupled to an upstream fuel feeder 12 for the fuel supply and an upstream air feeder 14 for the air supply. The reformer 16 is coupled to a down-stream fuel cell stack 20. The fuel cell stack 20 in this case comprises a plurality of fuel cells. However, as an alternative, instead of the fuel cell stack 20 just a single fuel cell may be provided. In particular, the reformer 16 is coupled to an anode of the fuel cell stack 20. In addition, the fuel cell stack 20 is coupled to a cathode air feeder 18 which supplies cathode air to a cathode of the fuel cell stack 20. In addition, the fuel cell stack 20 is coupled to an afterburner 24 which receives a supply of exhaust gas stemming, in this example embodiment, from both the anode and the cathode of the fuel cell stack 20. Coupled furthermore to the afterburner 24 is an afterburner air feeder 22 via which the afterburner 24 receives a supply of afterburner air. Assigned to the fuel cell system 10 is a controller 26. To obtain the air ratio of a reformer gas of the reformer 16 a lambda sensor 32 is provided at the reformer to which the controller 26 is coupled. Likewise provided for sensing the oxygengen content or oxygengen volume part of an afterburner exhaust gas of the afterburner 24 is a further lambda sensor 34 at the afterburner 24. For sensing an air volume flow supplied to the afterburner 24 a flow meter 30 is disposed between the afterburner air feeder 22 and the afterburner 24.

In operation the controller 26 performs the method in accordance with the invention as follows to map the anode conversion degree. Anode conversion degree is defined as the ratio of the combustion gases reacted by the anode to the combustion gases supplied to the anode and can be formulated as follows:

$${X}_{A} = \frac{N \frac{I}{2 F}}{{\sum }_{j = {H}_{2} , CO , BS} {\dot{n}}_{j}^{A , i n}} = \frac{N \frac{I}{2 F}}{N \frac{I}{2 F} + {\dot{n}}_{{H}_{2}}^{A , out} + {\dot{n}}_{CO}^{A , out} + {\dot{n}}_{BS}^{A , out}} .$$

Wherein N is the number of fuel cells of the fuel cell stack, F is the faraday constant in As/mol,

$${\sum }_{j = {H}_{2} , CO , BS} {\dot{n}}_{j}^{A , i n}$$

is the sum of the mol flows of H2, CO and of the fuel in mol/s entering the anode and the term \dot{n}_{H}_{₂}^{A,out}+\dot{n}_{CO}^{A,out}+\dot{n}_{BS}^{A,out} is the sum of the mol flows of H2, CO and of the fuel in mol/s emerging from the anode. So that the controller 26 can map the anode conversion degree it is necessary to sense the current I of the fuel cell stack 20. Preferably the current I is sensed when no additional fuel, particularly Diesel, is supplied to the afterburner 24. To sense the current I the controller 26 features an ammeter 28 suitably connected to the fuel cell stack 20 for sensing the current. If the current of the fuel cell stack 20 can be sensed, it is furthermore necessary to map the term \dot{n}_{H}_{₂}^{A,out}+\dot{n}_{CO}^{A,out}+\dot{n}_{BS}^{A,out} for computing the anode conversion degree X_{A}. This term can be written, among other things, in accordance with the definition of the air ratio as follows:

$${\dot{n}}_{{H}_{2}}^{A , out} + {\dot{n}}_{CO}^{A , out} + {\dot{n}}_{BS}^{A , out} = 2 \frac{1}{{λ}_{NB}} \frac{0.21 \cdot {\dot{V}}_{air}^{NB}}{60 \cdot {V}_{m , air}} .$$

Wherein \dot{V}ₐᵢᵣ^{NB} is the air volume flow entering afterburner 24 from the afterburner air feeder 22 in NI/s, □_{NB} is the air ratio or Lambda number of the afterburner exhaust gas of the afterburner 24 and V_{m,air} is the mol volume of the air in N1/mol. The mol volume of the air is known and can be obtained, for example, from the mol mass in conjunction with the specific volume of air. The controller 26 detects the air volume flow supplied to the afterburner 24 by means of the flow meter 30. It is then still necessary to compute the air ratio of the afterburner exhaust gas of the afterburner 24 by the controller 26. The air ratio of the afterburner exhaust gas is given by the following formula derivable for super-stoichiometric combustion

$${λ}_{NB} = \frac{1 + ( \frac{2}{{ϕ}^{A , out} ( {H}_{2} , CO )} - 1 ) \cdot {ϕ}_{NB} ( {O}_{2} )}{1 - \frac{{ϕ}_{NB} ( {O}_{2} )}{0.21}} .$$

In this formula, the term φ^{A,out} (H₂,CO) is a concentration of H₂ and CO at an anode outlet, in other words the concentration of gas leaving the anode, φ_{NB} (O₂) being a concentration O₂ in the afterburner exhaust gas. To obtain the concentration of O₂ in the afterburner exhaust gas the controller 26 is coupled to a lambda sensor 32 provided at the afterburner 24. To obtain the concentration of H₂ and CO at the anode outlet the controller 26 uses the following formula for the proportion of combustion gas in the anode exhaust gas leaving the anode:

$${ϕ}^{A , out} ( {H}_{2} , CO ) = {ϕ}^{A , i n} ( {H}_{2} , CO ) - I \cdot \frac{1}{{\dot{n}}_{Σ}^{A , i n}} \cdot \frac{N}{2 F} .$$

Wherein φ^{A,in} (H₂,CO) is the volume proportion or part of the gas comprising H₂ and CO supplied to the anode from the reformer 16, i.e. the proportion of H₂ and CO in the reformate, where

$$I \cdot \frac{1}{{\dot{n}}_{Σ}^{A , i n}} \cdot \frac{N}{2 F}$$

is the volume proportion of H₂ and CO converted in the fuel cell stack 20. More particularly, the expression \dot{n}_{Σ}^{A,in} relates to the total mol flow supplied to the anode at the anode inlet. To obtain φ^{A,in} (H₂,CO) the controller 26 uses an empirically established characteristic as a function of a reformer lambda respectively an air ratio of the reformer gas of the reformer 16 and determines

$${ϕ}^{A , i n} ( {H}_{2} , CO ) = {\sum }_{i = 0}^{4} {b}_{i} \cdot {λ}_{Ref}^{i} ,$$

where bᵢ is a predefined coefficient established empirically. To obtain the air ratio of the reformer gas the controller 26 is coupled to a lambda sensor 34 provided at the reformer 16. Likewise to obtain the total mol flow \dot{n}_{Σ}^{A,in} entering the anode the controller 26 uses the following formula:

$${\dot{n}}_{Σ}^{A , i n} = {\dot{n}}_{Σ}^{Ref , i n} \cdot {\sum }_{i = 0}^{2} {a}_{i} \cdot {λ}_{Ref}^{i} .$$

Analogously to the coefficient bᵢ the coefficient aᵢ is also established empirically in this case. It is especially possible with these coefficients as obtained empirically that characteristics can be produced for use in the corresponding calculation. In addition, \dot{n}_{Σ}^{Ref,in} is the notation for a total mol flow of the gases supplied to the reformer 16. This expression can be derived by the following formula for calculating the needed total mol flow entering the reformer \dot{n}_{Σ}^{Ref, in}:

$${\dot{n}}_{Σ}^{Ref , i n} = ( 1 + {λ}_{Ref} \cdot \frac{n + \frac{m}{4}}{0 , 21} ) \cdot \frac{{P}_{Ref}}{{h}_{u , fuel} \cdot {M}_{fuel}} .$$

Wherein n is a carbon proportion and m a hydrogen proportion of the fuel employed respectively supplied to the reformer. In addition P_{Ref} is a reformer power in Watt, h_{u,fuel} is a lower specific calorific value of the fuel in J/kg and M_{fuel} is the mol mass of the fuel, all of these variables being known. Accordingly, when the requirements are satisfied as cited above, the anode conversion degree can be estimated by means of the controller 26, since all variables needed for this purpose are either sensed or derived by the controller 26, as described above, by way of further formulae.

It is understood that the features of the invention as disclosed in the above description, in the drawings and as claimed may be essential to achieving the invention both by themselves or in any combination.

### LIST OF REFERENCE NUMERALS

10 fuel cell system
12 fuel feeder
14 air feeder
16 reformer
18 cathode air feeder
20 fuel cell stack
22 afterburner air feeder
24 afterburner
26 controller
28 ammeter
30 flow meter
32 lambda sensor
34 lambda sensor

1. A method for diagnosing an anode conversion degree in a fuel cell or fuel cell stack, comprising the step of:
diagnosing the anode conversion degree by measuring at least one current of the fuel cell or of the fuel cell stack, an air volume flow fed to an afterburner receiving no fuel supply at the time of measurement, an air ratio of a reformer gas and an oxygen volume proportion in an after-burner exhaust gas.

2. The method of claim 1, wherein the anode conversion degree is formed by the ratio of combustion gases converted by an anode at a current I to the combustion gases supplied to the anode as is defined by
$$\frac{N \frac{I}{2 F}}{{\sum }_{j = {H}_{2} , CO , BS} {\dot{n}}_{j}^{A , i n}} = \frac{N \frac{I}{2 F}}{N \frac{I}{2 F} + {\dot{n}}_{{H}_{2}}^{A , out} + {\dot{n}}_{CO}^{A , out} + {\dot{n}}_{BS}^{A , out}} ,$$
where I is the current of the fuel cell or of the fuel cell stack, N is the number of fuel cells, F is the faraday constant and \dot{n}_{H}_{₂}^{A,out}, \dot{n}_{CO}^{A,out}, \dot{n}_{BS}^{A,out} are each mol flows of H₂, CO and fuel at an anode outlet of emerging from the anode.

3. The method of claim 2, wherein the sum of the mol flows of \dot{n}_{H}_{₂}^{A,out}, \dot{n}_{CO}^{A,out}, \dot{n}_{BS}^{A,out} equals
$$2 \frac{1}{{λ}_{NB}} \frac{0.21 \cdot {\dot{V}}_{air}^{NB}}{60 \cdot {V}_{m , air}} ,$$
where \dot{V}ₐᵢᵣ^{NB} is the air volume flow supplied to the afterburner, □_{NB} is the air ratio of the afterburner exhaust gas and V_{m,air} is the mol volume of air.

4. The method of claim 3, wherein the air ratio of the afterburner exhaust gas is defined for super-stoichiometric combustion as
$${λ}_{NB} = \frac{1 + ( \frac{2}{{ϕ}^{A , out} ( {H}_{2} , CO )} - 1 ) \cdot {ϕ}_{NB} ( {O}_{2} )}{1 - \frac{{ϕ}_{NB} ( {O}_{2} )}{0.21}} ,$$
where φ^{A,out} (H₂,CO) is the volume proportion of H₂ and CO at the anode outlet and φ_{NB} (O₂) is the volume proportion of O₂ in the afterburner exhaust gas.

5. The method of claim 4, wherein that the volume proportion of H₂ and CO at the anode outlet is defined as
$${ϕ}^{A , out} ( {H}_{2} , CO ) = {ϕ}^{A , i n} ( {H}_{2} , CO ) - I \cdot \frac{1}{{\dot{n}}_{Σ}^{A , i n}} \cdot \frac{N}{2 F}$$
where φ^{A,in} (H₂,CO) is the volume proportion of H₂ and CO at an anode inlet of the and \dot{n}_{Σ}^{A,in} is the total mol flow at the anode inlet.

6. The method of claim 5, wherein the volume proportion of H₂ and CO at the anode inlet is mapped by means of characteristics as a function of the air ratio of the reformer gas.

7. The method of claim 5, wherein the total mol flow at the anode inlet is further mapped by means of characteristics as a function of the air ratio of the reformer gas.

8. The method of claim 7, wherein the total mol flow at the anode inlet is mapped as a function of a total mol flow into a reformer defined as
$${\dot{n}}^{Ref , i n} = ( 1 + {λ}_{Ref} \cdot \frac{n + \frac{m}{4}}{0 , 21} ) \cdot \frac{{P}_{Ref}}{{h}_{u , fuel} \cdot {M}_{fuel}} ,$$
where n is a carbon concentration and m is an hydrogen concentration of the fuel, h_{u,fuel} is the lower specific calorific value of the fuel, M_{fuel} is the mol mass of the fuel and P_{ref} is the reformer fuel power.

9. A fuel cell system including a controller suitable for performing the method of claim 1.
